(19) United States
(12) Patent Application Publication
(10) Pub. No.: US 2015/0173008 A1
(43) Pub. Date: Jun. 18, 2015

(54) PROACTIVE PROVISIONING OF POLICIES BY AN ANDSF SERVER

(71) Applicant: ALCATEL-LUCENT USA, INC., Murray Hill, NJ (US)

(72) Inventor: Kalyan P. SIDDAM, Cupertino, CA (US)

(73) Assignee: ALCATEL-LUCENT USA, INC., Murray Hill, NJ (US)

(21) Appl. No.: 14/105,453

(22) Filed: Dec. 13, 2013

(51) Int. Cl. H04W 48/18; H04W 4/02; H04W 48/16

(52) U.S. Cl. CPC H04W 48/18; H04W 48/16; H04W 4/02

(57) ABSTRACT

Various exemplary embodiments relate to a method, network node, and non-transitory machine-readable storage medium including one or more of the following: identifying, by an ANDSF server, an anticipated location for a user equipment device (UE) in communication with the ANDSF sever via an S14 session established over a first access network; generating, by the ANDSF server, a policy based on the anticipated location for the UE, wherein the policy includes an identification of an access point for use by the UE to access a second access network other than the first access network; and transmitting, by the ANDSF server, the policy including the identification of the access point to the UE via the S14 session over the first access network.

### TECHNICAL FIELD

Various exemplary embodiments disclosed herein relate generally to access network discovery and selection and, more particularly but not exclusively, to access network discovery and selection function (ANDSF) servers and clients.

### BACKGROUND

The evolution of cell phone and other communications has yielded numerous protocols and access networks for enabling communication between user equipment (UE) and the Internet or other networks. For example, access networks have been established according to LTE, 3GPP, CDMA 3GPP2), WiMAX, and WiFi standards. Increasingly, UEs such as smart phones are implementing the capability to connect to multiple types of access networks. For example, it is now common for smart phones to enable connection to WiFi access networks in addition to a cellular access network such as LTE. However, such UEs do not generally implement intelligent methods of deciding which access network to utilize and when; instead, it is often up to the user to manually enable communication via the desired access network or for the UE to periodically scan for available access networks and selecting one of them based on prior static configuration.

The third generation partnership project (3GPP) is currently developing a number of standards defining an “access network discovery and selection function” (ANDSF), including recent enhancements in release 12 for aiding the UE in automatically selecting alternative access networks for supporting some or all of the network traffic produced by the UE. However, while these standards provide general guidance on how an ANDSF should behave in some contexts, the standards are mostly silent on the internal operations of the various devices involved.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments relate to a method performed by an access network discovery and selection function (ANDSF) server for provisioning policies, the method comprising: identifying, by an ANDSF server, an anticipated location for a user equipment device (UE) in communication with the ANDSF sever via an S14 session established over a first access network; generating, by the ANDSF server, a policy based on the anticipated location for the UE, wherein the policy includes an identification of an access point for use by the UE to access a second access network other than the first access network; and transmitting, by the ANDSF server, the policy including the identification of the access point to the UE via the S14 session over the first access network.

Various embodiments relate to an access network discovery and selection function (ANDSF) server for provisioning policies, the ANDSF server comprising: a network interface in communication with a first access network; a storage device; and a processor in communication with the network interface and the storage device, wherein the processor is configured to: identify an anticipated location for a user equipment device (UE) in communication with the ANDSF sever via an S14 session established over the network interface, generate a policy based on the anticipated location for the UE, wherein the policy includes an identification of an access point for use by the UE to access a second access network other than the first access network, and transmit the policy including the identification of the access point to the UE via the S14 session over the network interface.

Various embodiments relate to a non-transitory machine-readable storage medium encoded with instructions for execution by an access network discovery and selection function (ANDSF) server for provisioning policies, the non-transitory machine-readable storage medium comprising: instructions for identifying, by an ANDSF server, an anticipated location for a user equipment device (UE) in communication with the ANDSF sever via an S14 session established over a first access network; instructions for generating, by the ANDSF server, a policy based on the anticipated location for the UE, wherein the policy includes an identification of an access point for use by the UE to access a second access network other than the first access network; and instructions for transmitting, by the ANDSF server, the policy including the identification of the access point to the UE via the S14 session over the first access network.

Various embodiments are described wherein transmitting the policy comprises pushing a message to the UE over the first access network, wherein the packet carries the policy.

Various embodiments additionally include, prior to identifying the anticipated location: receiving, from the UE, an identification of a location of the UE via the S14 session established over a first access network; and adding the identification of the location to a log of previous locations of the UE, wherein the step of identifying the anticipated location comprises performing analytics on the log of previous locations of the UE to determine the anticipated location.

Various embodiments are described wherein: the anticipated location comprises an identification of a GeoFence, the identification of the GeoFence is associated with a list of locations provided by an operator of the ANDSF server, and a UE within one of the locations of the list of locations is considered to be located within the GeoFence.

Various embodiments are described wherein the anticipated location comprises an identification of a tracking area code (TAC).

Various embodiments are described wherein the policy includes at least one of: an inter-system mobility policy (ISMP) which indicates a priority associated with the access point for use by the UE in determining whether to direct traffic over the second access network; and an inter-system routing policy (ISRP) which indicates routing criteria associated with the access point for use by the UE in identifying a subset of traffic to be directed over the second access network.

Various embodiments are described wherein the step of generating the policy is scheduled to be performed during off-peak hours.

Various embodiments are described wherein the step of identifying the anticipated location is performed in response to an action performed by an operator of the ANDSF server.

### BRIEF DESCRIPTION OF THE DRAWINGS

In order to better understand various exemplary embodiments, reference is made to the accompanying drawings, wherein:

FIG. 1 illustrates an exemplary environment for enabling communication via multiple access networks;

FIG. 2 illustrates an exemplary component diagram of an ANDSF server;

FIG. 3 illustrates an exemplary hardware diagram of an ANDSF server;

FIG. 4 illustrates an exemplary data arrangement for storing policy rules;

FIG. 5 illustrates an exemplary data arrangement for storing GeoFence definitions;

FIG. 6 illustrates an exemplary data arrangement for storing logs of previous UE locations;

FIG. 7 illustrates an exemplary method for proactively provisioning policies to a group of UEs; and

FIG. 8 illustrates an exemplary method for anticipating future locations of a UE.

To facilitate understanding, identical reference numerals have been used to designate elements having substantially the same or similar structure or substantially the same or similar function.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

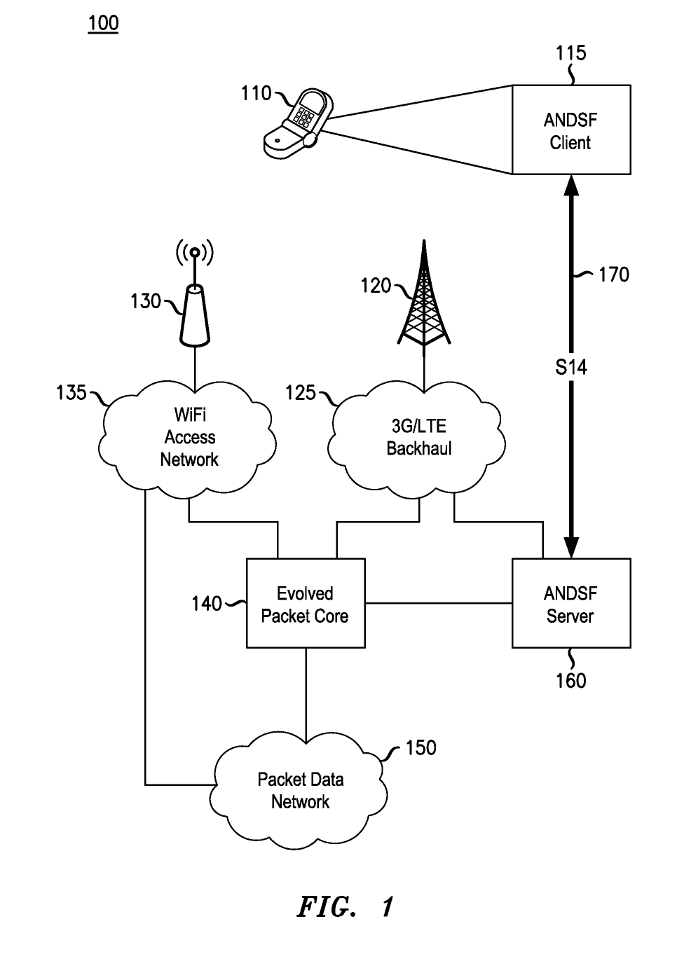

FIG. 1 illustrates an exemplary environment 100 for enabling communication via multiple access networks. The exemplary environment 100 may be a telecommunications network for providing user equipment (UE) 110 with access to a packet data network (PDN) 150, such as the Internet.

The UE 110 is a device that communicates with the packet data network 150 for providing the end-user with one or more data services. Such data service may include, for example, voice communication, text messaging, multimedia streaming, and Internet access. More specifically, in various exemplary embodiments, the UE 110 may be a personal or laptop computer, mobile or smart phone, tablet, television set-top box, or any other device capable of communicating with other devices via a network.

The environment 100 may include multiple routes for the UE 110 to access the PDN 150. For example, as part of a first route, the environment 110 includes a base station 120 and a 3G/LTE backhaul access network 125. The base station 120 may be a device that enables communication between user equipment 110 and the 3G/LTE backhaul access network 125. For example, the base station 120 may be a base transceiver station such as a radio network controller, nodeB, or an evolved nodeB (eNodeB) as defined by 3GPP standards. Thus, the base station 120 may be a device that communicates with the UE 110 via a first medium, such as radio waves, and communicates with the 3G/LTE backhaul access network 125 via a second medium, such as Ethernet cable. In various embodiments, multiple base stations (not shown) may be present to provide mobility to the UE 110.

The 3G/LTE backhaul access network 125 may be a series of routers, such as service aggregation routers, and other network elements configured to transport traffic to devices such as various devices belonging to an evolved packet core (EPC) 140. As will be explained in greater detail below, the EPC 140 may provide controlled and metered access to the PDN 150.

As part of a second route to the PDN 150, the exemplary environment includes a WiFi access point 130 and a WiFi access network 135. The WiFi access point 130 may be a device that enables communication between user equipment 110 and the WiFi access network 135. For example, the WiFi access point 130 may be a wireless router or other access point as defined by IEEE standards. Thus, the WiFi access point 130 may be a device that communicates with the UE 110 via a first medium, such as radio waves, and communicates with the WiFi access network 135 via a second medium, such as Ethernet cable. In various embodiments, multiple WiFi access points (not shown) may be present to provide mobility to the UE 110.

The WiFi access network 135 may be a series of routers and other network elements configured to transport traffic to devices such as various devices belonging to the EPC 140. As such, traffic that is redirected over the WiFi access network 135 may still be controlled and metered by the EPC 140 as will be detailed further below. Additionally, as shown, the WiFi access network 135 may enable non-seamless WiFi offload by providing a direct connection to the PDN, bypassing the EPC 140.

It will be appreciated that while the exemplary environment 100 is illustrated as including one WiFi access network and one 3G/LTE access network, various embodiments may include alternative or additional access networks. For example, an alternative environment (not shown) may include 3G/LTE access networks, WiFi access networks, WiMAX access networks, 3GPP access networks, or CDMA access networks. It will be apparent that the various principles described herein with respect to the 3G/LTE access network 125 and WiFi access network 135 may be applied to any combination of such access networks to achieve various benefits described herein.

In various embodiments, each of the access points 120, 130 may be associated with one or more identifiers. For example, the WiFi access point 130 may be associated with a unique SSID, or shared SSID along with a unique BSSID. As another example, the cellular access point may be associated with identifiers such as a cell ID, tracing area code (TAC), and location area code (LAC) which may be used to determine the current location of the UE 110.

The EPC 140 includes a collection of devices defined by the 3GPP to provide various services according to an LTE network. For example, the EPC 140 may include service gateways, PDN gateways, policy and charging rules function (PCRF) nodes, and subscription profile repositories (SPRs). The EPC 140 may manage UE sessions, authorize the transfer of application traffic to and from the PDN 150 upon request, enforce quality of service (QoS) limits and guarantees, meter network usage, apply charges to a subscribers account, or perform any other functions associated with an LTE EPC.

Various embodiments described herein facilitate the discovery of and selection among the available access networks 125, 135 for transport of data traffic by the UE 110. To this end, the UE 110 includes an access network discovery and selection function (ANDSF) client 115 that communicates with an ANDSF server 160 via an S14 session 170. As shown, the S14 session 170 is established via the 3G/LTE backhaul access network 125; in various embodiments, the S14 session 170 may be established over other available networks such as the WiFi access network 135 or other networks (not shown). In various embodiments, the S14 session may transfer messages on the data plane according to the Open Mobile Alliance (OMA) device management (DM) protocol. Various other protocols for the transfer of messages to implement the functionalities described herein will be apparent. In some embodiments, the ANDSF server 160 may have OMA-DM capability while, in other embodiments, the ANDSF server 160 may interface with an existing mobile device management (MDM) server within the carrier network over a proprietary interface. In some embodiments, the ANDSF sever 160 may support both co-located/embedded OMA-DM and standalone OMA-DM. In various embodiments, the ANDSF Server 160 may additionally or alternatively be connected to the WiFi Access Network 135 or Packet Data Network 150 such that the ANDSF Server 160 may be accessed or may access devices via networks other than the 3G/LTE backhaul network 125.

The ANDSF client 115 may establish the session by first transmitting identifying information (such as a triplet including IMSI, IMEI, and MSISDN values) to authenticate the subscriber using the UE 110. If the ANDSF server 160 is able to authenticate the subscriber as an existing and active subscriber, the ANDSF server 160 may create a new S14 session and transmit an S14 session identifier back to the ANDSF client 115 for use in future communications.

Once the S14 session 170 has been established, the ANDSF server 160 may assist the UE 110 by transmitting access network policies to the ANDSF client 115. As will be described in greater detail below, access network policies may include identifications of available access points, prioritization of access points, criteria for determining when to use various access points, or other information specified by the 3GPP as used by the UE 110 in automatically determining which access networks 125, 135 to utilize. Such policies may be delivered according to multiple procedures. In a PULL procedure, the ANDSF client 115 sends a message to the ANDSF server 160 requesting that access network policies be provided. The request message also includes information revealing the current location of the UE 110. For example, the location information may include a current cell identifier, location area code (LAC), tracking area code (TAC), public land mobile network (PLMN) identifier, GPS coordinates, or any other information useful in identifying a location. Based on the location information, the ANDSF server may identify nearby alternative access points and associated priorities, criteria, and other policy information. The generated policy is then returned to the ANDSF client 115 for use.

According to the PUSH procedure, the ANDSF server 160 provides policy information without having recently received a request from the ANDSF client 115. In other words, the ANDSF server 160 pushes an unsolicited set of policy information to the ANDSF client 115. Such a PUSH procedure may be used, for example, when policy information is modified by an operator of the ANDSF server 160 or when specifically requested by the operator. The pushed policy information may be based on the most recently reported location of the UE 110 or, as will be described in greater detail below, based on an anticipated future location of the ANDSF client 115.

In various embodiments, upon moving to a new location, the ANDSF client 115 may check a locally-stored policy database to determine whether any previously-received policies apply to the new location. For example, if the UE 115 reenters a previously visited location before the previously-received policies expire, the ANDSF 115 may locate the policies that were received from the ANDSF server 160 during the last visit to that area. When applicable policies are located locally, the ANDSF client 115 may proceed to utilize those policies, rather than requesting new policies via the S14 session 170. Leveraging this behavior, the ANDSF server 160 is able to pre-provision policies in the ANDSF client 115 for use in the future. Such pre-provisioning may be useful, for example, where the ANDSF server 160 enters a period of relatively low activity and may use extra capacity to generate policies. As will be described in greater detail below, the ANDSF server 160 described herein predicts future locations of the UE 110 based on information such as previously-reported locations of the UE 110 to pre-provision policies that are likely to be useful to the ANDSF client 115 in the future, should the UE 110 visit any of the anticipated locations.

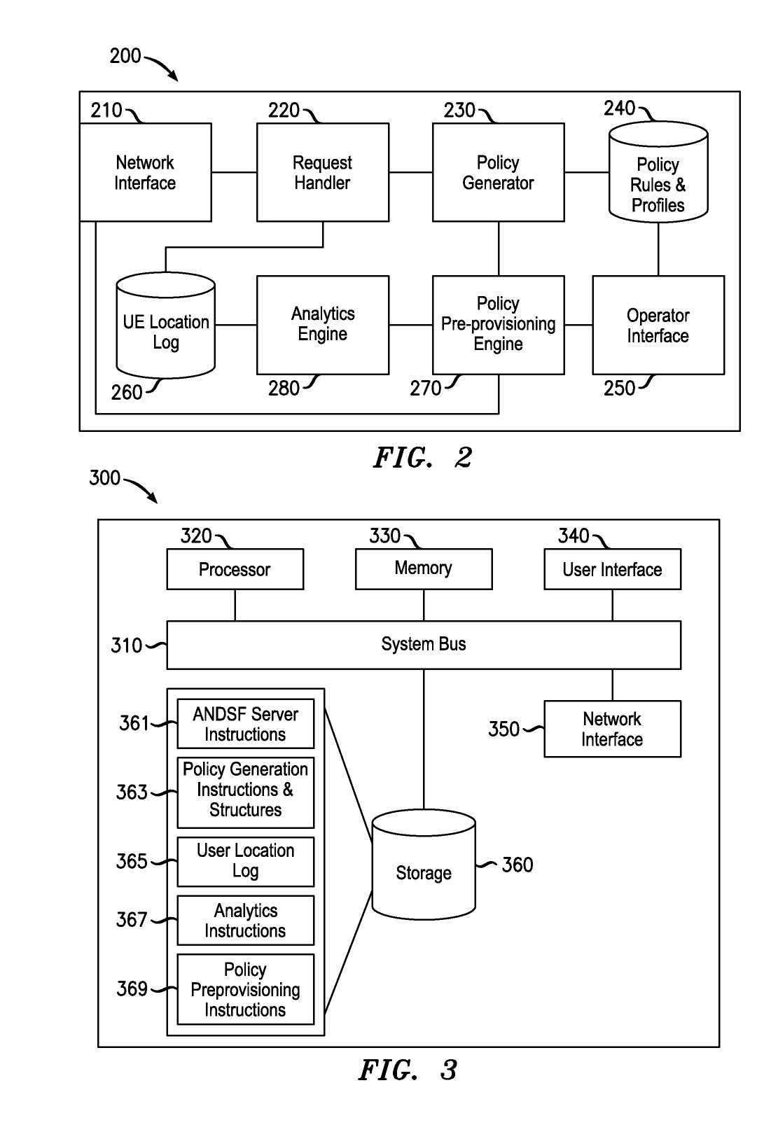

FIG. 2 illustrates an exemplary component diagram of an ANDSF server 200. The ANDSF server 200 may be a standalone device or may be a component of another system. For example, the ANDSF server 200 may correspond to the ANDSF server 160 of the exemplary environment 100. As another example, the ANDSF server 200 may be integrated into one of the devices belonging to the EPC 140 of the exemplary environment 100. Various other deployments for the ANDSF server 200 will be apparent.

The ANDSF server 200 includes multiple components for enabling the communications specified by the 3GPP standards. For example, as shown, the ANDSF server 200 includes a network interface 210, request handler 220, policy generator 230, and policy rules and profiles storage 240. Together, these components 210, 220, 230, 240 may facilitate responding to an ANSDF client PULL request. It will be apparent that FIG. 2 may constitute an abstraction or simplification in some respects and that additional components may be included for performing this or other functions. For example, additional components (not shown) may be included for establishing new S14 sessions. Various other modifications will be apparent.

The network interface 210 may include hardware or executable instructions on a machine-readable storage medium configured to exchange messages with other devices according to one or more communications protocols. For example, the network interface 210 may include an Ethernet or TCP/IP interface. The network interface 210 may implement various other protocol stacks such as, for example, an OMA-DM or HTTP(S) stack. In various embodiments, the network interface 210 may include multiple physical ports.

The request handler 220 may include hardware or executable instructions on a machine-readable storage medium configured to interpret received messages to identify S14 session modification requests which include pull requests for policy information. Upon identifying such a pull request, the request handler may perform authentication such as, for example, determining whether an S14 session identifier carried by the request message corresponds to an active S14 session. After verifying that the ANDSF server 200 recognizes the session with which the request is associated, the request handler 220 invokes the policy generator 230 to create a policy for inclusion in a response message. Invocation of the policy generator 230 may include passing various information to the policy generator 230 such as, for example, location information carried by the request or subscriber information retrieved from an SPR by the request handler 220 or another component.

Upon receiving a policy from the policy generator 230, the request handler 220 constructs a response message to the requesting ANDSF client. The response message may be formed according to the S14 protocol and carry the generated policy. The request handler 220 then sends the response message back to the ANDSF client via the network interface 210.

The policy generator may include hardware or executable instructions on a machine-readable storage medium configured to identify or otherwise generate a policy to be transmitted to an ANDSF client. In some embodiments, the policy generator includes a rules engine that evaluates one or more externalized rules stored in the policy rules and profiles storage 240 to determine, based on the context of the request, what policy should be sent to the ANDSF client. As will be described in greater detail below with respect to FIG. 4, the rules may be evaluated against context information such as a provided UE location. In some embodiments, the policy generator 230 may additionally or alternatively evaluate policy profiles for generating various components of an ANDSF policy such as, for example, an inter-system mobility policy (ISMP) or an inter-system routing policy (ISRP).

The policy rules and profiles storage 240 may be any machine-readable medium capable of storing one or more rules or profiles for evaluation by the policy generator 230. Accordingly, the policy rules and profiles storage 240 may include a machine-readable storage medium such as read-only memory (ROM), random-access memory (RAM), magnetic disk storage media, optical storage media, flash-memory devices, and/or similar storage media. Exemplary contents for the policy rules and profiles storage 240 will be described in greater detail below with respect to FIG. 4.

The ANDSF server 200 also enables operator configuration and, in some embodiments, includes an operator interface 250. The operator interface may include local interface components such as, for example, a monitor, mouse, and keyboard along with a graphical user interface (GUI) for enabling configuration of the ANDSF server 200 such as by, for example, defining rules or policies stored in the policy rules and profiles storage 240. In some embodiments, the operator interface may enable presentation of a GUI to a remote server via the network interface 210. Various other operator interfaces 250 for enabling operator configuration of the ANDSF server 200 will be apparent.

In various embodiments, the ANDSF server 200 may be capable of pre-provisioning ANDSF policies to ANDSF clients based on anticipating future locations. To facilitate such functionality, the ANSDF server 200 is shown to include a UE location log storage 260, policy pre-provisioning engine 270, and analytics engine 280.

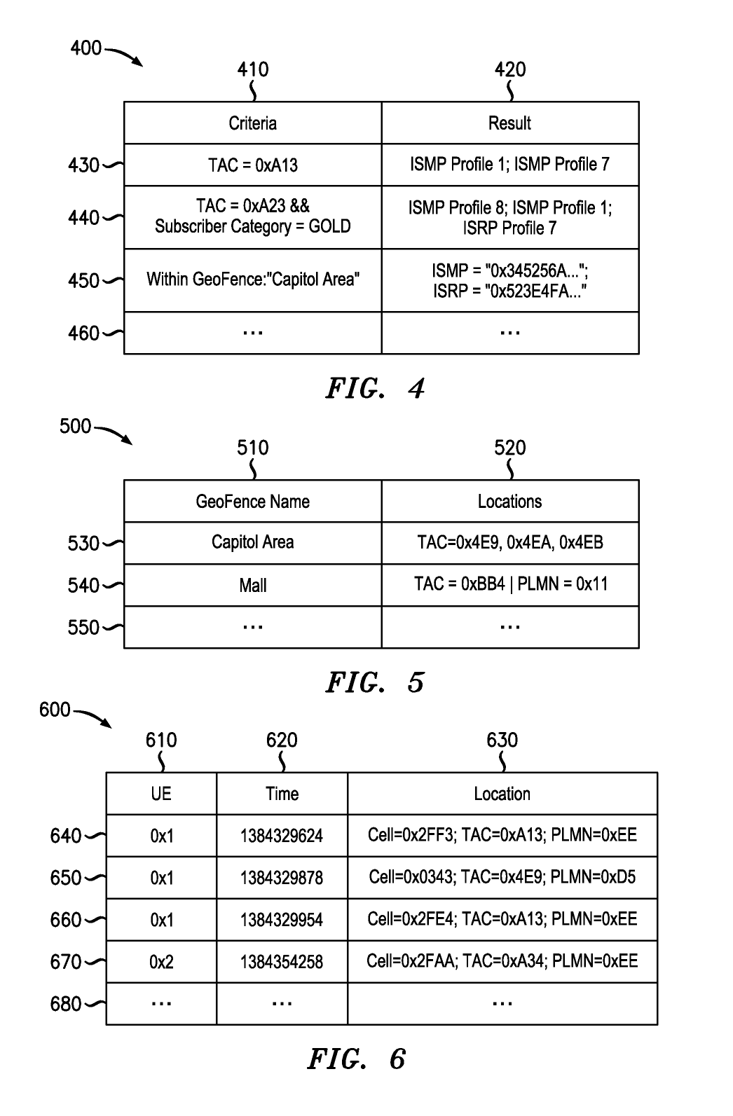

The UE log storage 260 may be any machine-readable medium capable of storing a log of previously reported UE locations. Accordingly, the UE log storage 260 may include a machine-readable storage medium such as read-only memory (ROM), random-access memory (RAM), magnetic disk storage media, optical storage media, flash-memory devices, and/or similar storage media. Exemplary contents for the UE log storage 260 will be described in greater detail below with respect to FIG. 6. In various embodiments, the UE log storage 260 may refer to the same physical device at the policy rules and profiles storage 240.

In embodiments including the UE log storage 260, the request handler 220 may be additionally configured to store log entries in the UE log storage 260 when an ANDSF client reports a UE location. For example, when the request handler 220 receives a PULL request, the request handler 220 may extract the reported location from the message and create a timestamped entry in the user location log 260. Various other messages may be used by the request handler 220 or other components to create log entries to be stored in the UE log storage 260. For example, the ANDSF server 200 may periodically poll known ANDSF clients for current location information, which is then stored in the user location log storage 260.

The policy pre-provisioning engine 270 may include hardware or executable instructions on a machine-readable storage medium configured to initiate a PUSH procedure for pre-provisioning policies to an ANDSF client. For example, the policy pre-provisioning engine 270 may be configured to audit a group of S14 sessions periodically or in response to an operator action received via the operator interface 250. For example, the operator may perform an action such as manually requesting the S14 session audit or updating the contents of policy rules and profiles storage 240. Various other operator actions for triggering an S14 session audit will be apparent.

An S14 session audit may also be performed for varying groups of sessions. For example, the audit may be performed for a single S14 session or for all known S14 sessions. Further, the group of sessions may be identified by virtue of sharing a common characteristic. For example, the S14 session audit may apply to all S14 sessions currently located within a specific geographic area or S14 sessions associated with a specific subscriber class. The criteria for selecting S14 sessions for audit may be specified by the operator or determined based on other factors such as the characteristics of rules or policies that have been updated.

Where the policy pre-provisioning engine 270 performs session audits on a scheduled basis, it may be advantageous to schedule such session audits during off-peak hours. For example, an operator may explicitly define times of day that are considered off-peak and the session audits may be scheduled to be performed during these times. As another example, the ANDSF server 200 may be aware of times of day where EPC or other network activity is relatively lower than other times of day based on reports or other gathered data. In such embodiments, the ANDSF server 200 may select times during these windows of lower activity to perform session audits. Various other methods of identifying off-peak hours will be apparent.

Once the policy pre-provisioning engine 270 has identified a group of S14 sessions to audit, the policy pre-provisioning engine 270 iterates through each S14 session in the group to perform any useful pre-provisioning. To begin, the policy pre-provisioning engine 270 first requests a list of anticipated UE locations for the S14 session from the analytics engine 270. Where the returned list includes at least one anticipated location, the policy pre-provisioning engine 270 then passes each anticipated location to the policy generator 230 for generation of one or more policies. The policy generator 230 may then generate the policies as described above and return the results to the policy pre-provisioning engine 270. If the policy pre-provisioning engine 270 receives at least one policy from the policy generator 230, the policy pre-provisioning engine 270 then constructs a PUSH message including the policies and transmits the PUSH message to the ANDSF client associated with the current S14 session.

The analytics engine 280 may include hardware or executable instructions on a machine-readable storage medium configured to attempt to anticipate UE locations upon request. In some embodiments, the analytics engine 280 retrieves logged locations for a UE associated with an identified S14 session from the user location log storage 260 for the purpose of predicting one or more future locations of the UE. In some embodiments, the analytics engine 280 may only retrieve log entries that are within a specific window such as, for example, log entries that are not older than a week or a month. In other embodiments, the analytics engine 280 retrieves all log entries available for the UE. In some such embodiments, the ANDSF server 200 may implement a cleanup procedure wherein the user location log storage 260 is periodically audited to remove “stale” log entries. Alternatively, the ANDSF server 200 may remove all log entries for a UE whenever an S14 session for that UE is terminated.

After retrieving the relevant log entries, the analytics engine 280 may perform various analytics procedures to predict one or more future locations of the UE. Such analytics may incorporate any methods useful for processing logged location information to predict future locations. One example of such a method will be described in greater detail below with respect to FIG. 8. After completing the analysis of the UE location log, the analytics engine 280 returns a list of anticipated locations to the policy pre-provisioning engine 270 or other requesting component.

It will be apparent that the exemplary ANDSF server 200 may be an abstraction and that additional components may be included. For example, an ANDSF server may also include additional storage for storing access network cartography information. As another example, an ANDSF server may include a component that interfaces with a subscriber profile repository (SPR) to obtain home zone information. Various other external devices may also provide input to influence policy generation such as, for example, a network probe that reports network congestion.

FIG. 3 illustrates an exemplary hardware diagram of an ANDSF server 300. The exemplary ANDSF server 300 may correspond to the ANDSF server 200 of FIG. 2 or the ANDSF server 160 of FIG. 1. As shown, the ANDSF server 300 includes a processor 320, memory 330, user interface 340, network interface 350, and storage 360 interconnected via one or more system buses 310. It will be understood that FIG. 3 constitutes, in some respects, an abstraction and that the actual organization of the components of the ANDSF server 300 may be more complex than illustrated.

The processor 320 may be any hardware device capable of executing instructions stored in memory 330 or storage 360. As such, the processor may include a microprocessor, field programmable gate array (FPGA), application-specific integrated circuit (ASIC), or other similar devices.

The memory 330 may include various memories such as, for example L1, L2, or L3 cache or system memory. As such, the memory 330 may include static random access memory (SRAM), dynamic RAM (DRAM), flash memory, read only memory (ROM), or other similar memory devices.

The user interface 340 may include one or more devices for enabling communication with a user such as an administrator. For example, the user interface 340 may include a display, a mouse, and a keyboard for receiving user commands.

The network interface 350 may include one or more devices for enabling communication with other hardware devices. For example, the network interface 350 may include a network interface card (NIC) configured to communicate according to the Ethernet protocol. Additionally, the network interface 350 may implement a TCP/IP stack for communication according to the TCP/IP protocols. Various alternative or additional hardware or configurations for the network interface 350 will be apparent.

The storage 360 may include one or more machine-readable storage media such as read-only memory (ROM), random-access memory (RAM), magnetic disk storage media, optical storage media, flash-memory devices, or similar storage media. In various embodiments, the storage 360 may store instructions for execution by the processor 320 or data upon with the processor 360 may operate. For example, the storage 360 may store ANSDF server instructions 361 for implementing basic ANDSF server functionality such as, for example, S14 session establishment and S14 message processing. The storage 360 may also store policy generation instructions and structures for use in generating policies to be provisioned to ANSDF clients. To facilitate proactive policy pre-provisioning, the storage 360 may also store a user location log 365 to be used by analytics instructions 367 for anticipating a future UE location. The storage 360 is also shown as including policy pre-provisioning instructions 369 for determining when to pre-provision policies to ANDSF clients and for pushing such policies to the ANDSF clients.

It will be apparent that various information described as stored in the storage 360 may be additionally or alternatively stored in the memory 330. For example, the user location log 365 may be additionally, alternatively, or partially stored in the memory 330. In this respect, the memory 330 may also be considered to constitute a “storage device.” Various other arrangements will be apparent. Further, the memory 330 and storage 360 may both be considered to be “non-transitory machine-readable media.” As used herein, the term “non-transitory” will be understood to exclude transitory signals but to include all forms of storage, including both volatile and non-volatile memories.

While the ANDSF server 300 is shown as including one of each described component, the various components may be duplicated in various embodiments. For example, the processor 320 may include multiple microprocessors that are configured to independently execute the methods described herein or are configured to perform steps or subroutines of the methods described herein such that the multiple processors cooperate to achieve the functionality described herein. In some embodiments, such as those wherein the ANSDF server is implemented in a cloud computing architecture, components may be physically distributed among different devices. For example, the processor 320 may include a first microprocessor in a first data center and a second microprocessor in a second data center. Various other arrangements will be apparent.

FIG. 4 illustrates an exemplary data arrangement 400 for storing policy rules. As such, the data arrangement 400 may be stored in a memory 330 or storage device 360 of the ANDSF server 300 and may reflect contents of the policy rules and profiles storage 240. It will be apparent that the data arrangement 400 may be an abstraction and may be stored in any manner known to those of skill in the art such as, for example, a table, linked list, array, database, or other structure. In some embodiments, the data arrangement 400 may be accessible using a query language such as, for example, the structured query language (SQL).

The data arrangement 400 includes a criteria field 410 and a result field 420. The criteria field 410 may indicate one or more conditions for determining whether a rule is applicable to a current context. The result field 420 may indicate information to be used in generating a policy when a rule is applicable.

As a first example, rule 430 indicates that it is to be applied when a tracking area code (TAC) of the UE is currently (or anticipated to be) “0xA13.” The rule 430 also indicates that, when applicable, two policy profiles, “ISMP Profile 1” and “ISRP Profile 7” are to be evaluated to generate a policy.

As another example, rule 440 indicates that it is to be applied when both a TAC of the UE is currently (or anticipated to be) “0xA23” and a subscriber category of a subscriber associated with the UE is “GOLD.” The rule 440 also indicates that, when applicable, three policy profiles, “ISMP Profile 8,” “ISMP Profile 1,” and “ISRP Profile 7” are to be used and potentially evaluated to generate a policy.

It will be noted that location may be defined by values other than TAC. For example, a rule may be evaluated against a cell identifier, LAC, TAC, PLMN identifier, or GPS coordinates. In some embodiments, locations may be identified using an operator-defined “GeoFence.” As will be described further below with respect to FIG. 5, a GeoFence may be associated with a geographic area on the ANSDF server but not known to the ANSDF clients. As an example, rule 450 indicates that it is applicable when the UE is currently (or anticipated to be) within the GeoFence identified as “Capitol Area.” Rule 450 also shows an example of a rule explicitly defining policy data rather than referring to a separate policy profile for evaluation. As such, rule 450 shows that, when applicable, the ISMP “0x345256A . . . ” and ISRP “0x523E4FA . . . ” should be used. The data arrangement 400 may include numerous additional rules 460.

FIG. 5 illustrates an exemplary data arrangement 500 for storing GeoFence definitions. As such, the data arrangement 500 may be stored in a memory 330 or storage device 360 of the ANDSF server 300. It will be apparent that the data arrangement 500 may be an abstraction and may be stored in any manner known to those of skill in the art such as, for example, a table, linked list, array, database, or other structure. In some embodiments, the data arrangement 500 may be accessible using a query language such as, for example, the structured query language (SQL).

The data arrangement 500 includes a GeoFence name field 510 and a locations field 520. The GeoFence name field 510 may provide a handle for each GeoFence, such that rules and other processes or structures may refer to a GeoFence. The locations field 520 may identify one or more non-GeoFence location identifiers to which the GeoFence corresponds.

As an example, GeoFence definition 530 indicates that a UE is considered within the “Capitol Area” GeoFence when the UE is reported to be located in any of the TACs “0x4E9,” “0x4EA,” or “0x4EB ” Likewise, a UE may be predicted to be within the “Capitol Area” GeoFence in the future if the UE is predicted to enter any of these TACs. As another example, GeoFence definition 540 indicates that a UE is considered (or anticipated) to be within the “Mall” GeoFence when the UE is reported (or anticipated) to be located either within TAC “0xBB4” or PLMN “0x11.” Various alternative methods of defining geographic locations will be apparent. For example, a geographic location may be defined by one or more cell identifiers or apoint, such as GPS coordinates, along with a radius thereby identifying the area within the circle defined by the point and radius. The data arrangement 500 may include numerous additional GeoFence definitions 550.

FIG. 6 illustrates an exemplary data arrangement 600 for storing logs of previous UE locations. As such, the data arrangement 600 may be stored in a memory 330 or storage device 360 of the ANDSF server 300 and may describe contents of the user location log storage 260. It will be apparent that the data arrangement 600 may be an abstraction and may be stored in any manner known to those of skill in the art such as, for example, a table, linked list, array, database, or other structure. In some embodiments, the data arrangement 600 may be accessible using a query language such as, for example, the structured query language (SQL).

The data arrangement 600 includes a UE field 610, a time field 620, and a location field 630. The UE field 610 may include an identification of a UE with which a log entry is associated. It will be apparent that in some embodiments a log entry may be associated with entities other than UEs. For example, the data arrangement 600 may include fields (not shown) identifying an S14 session or subscriber to which a log entry applies. The time field 620 indicates when a log entry was recorded. This value may be used to determine when a UE may re-enter the location identified by the log entry or when to clean up the log entry as stale. The location field 630 may include one or more indications of a location occupied by the UE such as, for example, a cell ID, TAC, LAC, PLMN ID, GPS coordinates, or GeoFence.

As an example, log entries 640, 650, 660 are all related to a UE “0x1.” Log entry 640 shows that at time “1384329624,” the UE was reported to be at a location identified as “Cell=0x2FF3; TAC=0xA13; PLMN=0xEE.” Log entry 650 shows that at time “1384329878,” the UE was reported to move to a location identified as “Cell=0x0343; TAC=0x4E9; PLMN=0xD5.” Log entry 660 shows that at time “1384329954,” the UE returned to the location identified as “Cell=0x2FF3; TAC=0xA13; PLMN=0xEE.” From these log entries, an analytics engine might conclude that the UE is likely to revisit “Cell=0x2FF3; TAC=0xA13; PLMN=0xEE” the next day. As will be understood, various additional or alternative conclusions may be drawn by different analytics engines at different times of day.

The data arrangement 600 may include log entries for other UE devices as well. As an example, log entry 670 indicates that UE “0x2” was at location “Cell=0x2FF3; TAC=0xA13; PLMN=0xEE” at time “1384354258.” The data arrangement 600 may include numerous additional log entries 680.

It will be apparent that various alternative or additional fields may be included in the data arrangement 600. For example, a score field (not shown) may be provided in the data arrangement 600 or elsewhere within the ANDSF server storage. The value in the score field may be incremented each time a UE visits the same location. In this manner, the ANDSF server may maintain a view into which location are frequented by the UE.

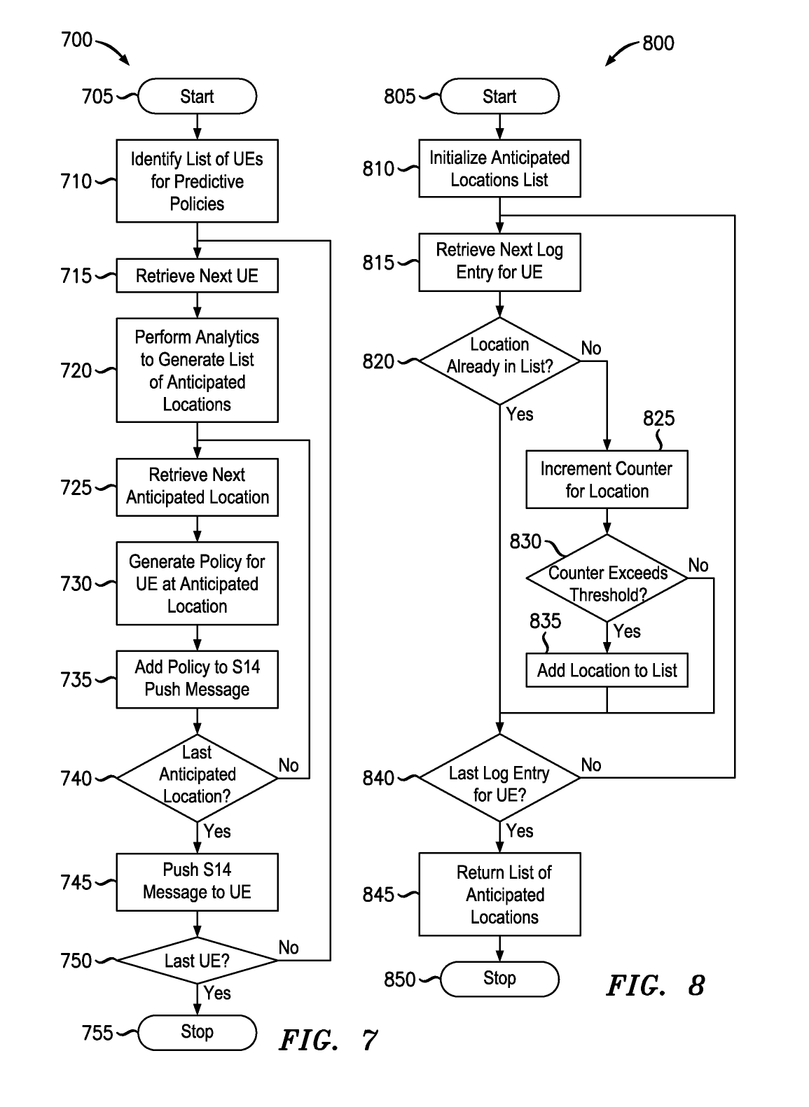

FIG. 7 illustrates an exemplary method 700 for proactively provisioning policies to a group of UEs. The method 700 may be performed by the components of an ANDSF server, such as the policy generator 230, policy pre-provisioning engine 270, and analytics engine 280 of the exemplary ANDSF server 200. The method 700 may be executed periodically, such as during off-peak hours, or upon operator action, such as manually requesting execution.

The method 700 begins in step 705 and proceeds to step 710 where the ANDSF server identifies a list of UEs for which policy prediction will be performed. For example, the ANDSF server may identify a list of all S14 sessions known or may identify all S14 sessions identified or potentially affected by an operator action. Next, in step 715, the ANDSF server retrieves a UE to evaluate from the list of UEs. In step 720, the ANDSF server performs one or more analytics operations to identify one or more anticipated locations for the UE. An exemplary analytics method will be described in greater detail with respect to FIG. 8.

After identifying a list of anticipated locations for the current UE, the ANDSF server proceeds to select a first anticipated location from the list in step 725 and generate a policy based on the anticipated location in step 730. This generation may include the application of one or more policy rules or the evaluation of one or more policy profiles, as detailed in the related applications incorporated herein. Additionally or alternatively, generation of a policy may include retrieving a policy stored in memory, such as a previously generated policy. The ANDSF server then, in step 735, adds the generated policy to an S14 message for transmission to the ANDSF client on the current UE.

In step 740, the ANDSF server determines whether additional anticipated locations for the current UE remain to be processed. If so, the method 700 may loop back to step 725 where the ANDSF server may proceed to process the subsequent anticipated locations in the list. Otherwise, the ANDSF server may push the S14 message to the ANDSF client on the current UE in step 745. It will be apparent that S14 messages may be pushed at different points in the method 700. For example, a message may be pushed in place of step 735 or S14 messages may be pushed as a batch prior to step 755.

In step 750, the ANDSF server determines whether additional UEs remain to be processed. If so, the method 700 may loop back to step 715 where the ANDSF server may proceed to process the subsequent UEs in the list. Otherwise, the method may proceed to end in step 755.

FIG. 8 illustrates an exemplary method 800 for anticipating future locations of a UE. The method 800 may be performed by the components of an ANDSF server, such as analytics engine 280 of the exemplary ANDSF server 200. The method 800 may be executed upon request by another component such as the policy pre-provisioning engine 270. Further, while the method 800 identifies one possible analytics method, it will be apparent that various alternative analytics methods of varying complexity may be employed. In various embodiments, the method 800 may correspond to step 720 in the method 700 for pre-provisioning policies.

The method 800 begins in step 805 and proceeds to step 810 where the ANDSF server initializes a new, empty list of anticipated locations. Next, in step 815, the ANDSF server may retrieve a first log entry for the current UE. In various embodiments, the ANDSF server may simply locate the first encountered log entry for the current UE while, in other embodiments, the ANDSF server may locate a log entry for the UE that was recorded within an applicable time window. In step 820, ANDSF server may determine whether the location identified by the current log entry has already been added to the list of anticipated location. If so, the method 800 skips further processing of the log entry and proceeds to step 840. Otherwise, the method 800 proceeds to step 825.

In step 825, the ANDSF server increments a counter associated with the location identified by the current log entry. In various embodiments, the ANDSF server may increment the counter by one (indicating an additional logged visit) or may increment the counter by the difference between the current log entry timestamp and the next log entry timestamp (indicating additional duration spent at the location). In step 830, the ANDSF server determines whether the recently incremented counter now exceeds a predetermined threshold for inclusion in the anticipated locations list. For example, the ANDSF server may be configured to anticipate that a UE may revisit a location that has been visited 10 times in the last month or for a total of 20 hours in the last week. If the counter now exceeds the threshold, the ANDSF server adds the location to the anticipated location list in step 835.

In step 840, the ANDSF server determines whether additional log entries remain to be processed for the UE. If so, the method 800 loops back to step 815 where the ANDSF server may proceed to process the next log entry for the UE. Otherwise, the ANDSF server returns the completed list of anticipated locations in step 845 and the method 800 proceeds to end in step 850.

In some embodiments, the ANDSF server may be additionally configured to address the possibility of losing a UE's location or otherwise not being apprised on changes in location dues to a the UE's receipt of a pre-provisioned ANDSF policy according to the foregoing methods. For example, as a first option, when a UE has not reported a location or queried for an ANDSF policy for the locations the ANDSF server had pre-provisioned, the ANDSF server may assume that the pre-provisioned policy was used and record an additional UE visit to the associated location. As a second option, when the UE has not reported a location that is different from the anticipated location in the timeslot the ANDSF server had anticipated, the ANDSF server may assume that UE visited the location and record an additional UE visit to the associated location. As a third option, the UE may report the ANDSF policy that it used and the timestamp indicating when it was used. This third option may include providing for the ANDSF client to report metrics on ANDSF policy matching. It will be apparent that these three options are not mutually exclusive and may be used in combination together or with other methods for maintaining location log consistency in light of pre-provisioned policies.

According to the foregoing, various embodiments enable the proactive pre-provisioning of ANDSF policies to ANDSF clients. In particular, by analyzing historical locations of a UE device, an ANDSF server may anticipate likely future locations for the ANDSF. The ANDSF server may then pre-provision policies in the ANDSF client for the anticipated locations during off-peak times, thereby releasing the use of these resources during peak times for other tasks. Various additional benefits will be apparent in view of the foregoing.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by an access network discovery and selection function (ANDSF) server for provisioning policies, the method comprising:
identifying, by an ANDSF server, an anticipated location for a user equipment device (UE) in communication with the ANDSF sever via an S14 session established over a first access network;
generating, by the ANDSF server, a policy based on the anticipated location for the UE, wherein the policy includes an identification of an access point for use by the UE to access a second access network other than the first access network; and
transmitting, by the ANDSF server, the policy including the identification of the access point to the UE via the S14 session over the first access network.

2. The method of claim 1, wherein transmitting the policy comprises pushing a message to the UE over the first access network, wherein the packet carries the policy.

3. The method of claim 1, further comprising, prior to identifying the anticipated location:
receiving, from the UE, an identification of a location of the UE via the S14 session established over a first access network; and
adding the identification of the location to a log of previous locations of the UE,
wherein the step of identifying the anticipated location comprises performing analytics on the log of previous locations of the UE to determine the anticipated location.

4. The method of claim 1, wherein:
the anticipated location comprises an identification of a GeoFence,
the identification of the GeoFence is associated with a list of locations provided by an operator of the ANDSF server, and
a UE within one of the locations of the list of locations is considered to be located within the GeoFence.

5. The method of claim 1, wherein the anticipated location comprises an identification of a tracking area code (TAC).

6. The method of claim 1, wherein the policy includes at least one of:
an inter-system mobility policy (ISMP) which indicates a priority associated with the access point for use by the UE in determining whether to direct traffic over the second access network; and
an inter-system routing policy (ISRP) which indicates routing criteria associated with the access point for use by the UE in identifying a subset of traffic to be directed over the second access network.

7. The method of claim 1, wherein the step of generating the policy is scheduled to be performed during off-peak hours.

8. The method of claim 1, wherein the step of identifying the anticipated location is performed in response to an action performed by an operator of the ANDSF server.

9. An access network discovery and selection function (ANDSF) server for provisioning policies, the ANDSF server comprising:
a network interface in communication with a first access network;
a storage device; and
a processor in communication with the network interface and the storage device, wherein the processor is configured to:
identify an anticipated location for a user equipment device (UE) in communication with the ANDSF sever via an S14 session established over the network interface,
generate a policy based on the anticipated location for the UE, wherein the policy includes an identification of an access point for use by the UE to access a second access network other than the first access network, and
transmit the policy including the identification of the access point to the UE via the S14 session over the network interface.

10. The ANDSF server of claim 9, wherein transmitting the policy comprises pushing a message to the UE over the first access network, wherein the packet carries the policy.

11. The ANDSF server of claim 9, wherein:
the storage device is configured to store a log of previous locations of the UE, and
in identifying the anticipated location, the processor is configured to perform analytics on the log of previous locations of the UE to determine the anticipated location.

12. The ANDSF server of claim 9, wherein:
the storage device stored an association between an identification of a GeoFence and a list of locations provided by an operator of the ANDSF server, wherein a UE within one of the locations of the list of locations is considered to be located within the GeoFence, and
the anticipated location comprises an identification of the GeoFence.

13. The ANDSF server of claim 9, wherein the anticipated location comprises an identification of a tracking area code (TAC).

14. The ANDSF server of claim 9, wherein the policy includes at least one of:
an inter-system mobility policy (ISMP) which indicates a priority associated with the access point for use by the UE in determining whether to direct traffic over the second access network; and
an inter-system routing policy (ISRP) which indicates routing criteria associated with the access point for use by the UE in identifying a subset of traffic to be directed over the second access network.

15. The ANDSF server of claim 9, wherein the processor is scheduled to perform the policy generation during off-peak hours.

16. The ANDSF server of claim 9, wherein the processor performs the identification of the anticipated location in response to an action performed by an operator of the ANDSF server.

17. A non-transitory machine-readable storage medium encoded with instructions for execution by an access network discovery and selection function (ANDSF) server for provisioning policies, the non-transitory machine-readable storage medium comprising:
instructions for identifying, by an ANDSF server, an anticipated location for a user equipment device (UE) in communication with the ANDSF sever via an S14 session established over a first access network;
instructions for generating, by the ANDSF server, a policy based on the anticipated location for the UE, wherein the policy includes an identification of an access point for use by the UE to access a second access network other than the first access network; and
instructions for transmitting, by the ANDSF server, the policy including the identification of the access point to the UE via the S14 session over the first access network.

18. The non-transitory machine-readable storage medium of claim 17, wherein the instructions for transmitting the policy comprise instructions for pushing a message to the UE over the first access network, wherein the packet carries the policy.

19. The method of claim 17, further comprising instructions for, prior to identifying the anticipated location:
receiving, from the UE, an identification of a location of the UE via the S14 session established over a first access network; and
adding the identification of the location to a log of previous locations of the UE,
wherein the instructions for identifying the anticipated location comprise instructions for performing analytics on the log of previous locations of the UE to determine the anticipated location.

20. The non-transitory machine-readable storage medium of claim 17, wherein:
the anticipated location comprises an identification of a GeoFence,
the identification of the GeoFence is associated with a list of locations provided by an operator of the ANDSF server, and
a UE within one of the locations of the list of locations is considered to be located within the GeoFence.

21. The non-transitory machine-readable storage medium of claim 17, wherein the anticipated location comprises an identification of a tracking area code (TAC).

22. The non-transitory machine-readable storage medium of claim 17, wherein the policy includes at least one of:
an inter-system mobility policy (ISMP) which indicates a priority associated with the access point for use by the UE in determining whether to direct traffic over the second access network; and
an inter-system routing policy (ISRP) which indicates routing criteria associated with the access point for use by the UE in identifying a subset of traffic to be directed over the second access network.

23. The non-transitory machine-readable storage medium of claim 17, wherein the instructions for generating the policy are configured to be performed during off-peak hours.

24. The non-transitory machine-readable storage medium of claim 17, wherein the instructions for identifying the anticipated location are configured to be executed in response to an action performed by an operator of the ANDSF server.
